(19) United States
(12) Patent Application Publication
(10) Pub. No.: US 2026/0190134 A1
(43) Pub. Date: Jul. 2, 2026

(54) DYNAMIC INTERFERENCE MITIGATION FOR SATELLITE AND TERRESTRIAL NETWORKS

(71) Applicant: T-MOBILE INNOVATIONS LLC, Overland Park, KS (US)

(72) Inventor: Chaitanya CHUKKA, Plainfield, IL (US)

(21) Appl. No.: 19/007,001

(22) Filed: Dec. 31, 2024

(51) Int. Cl. H04W 72/541; H04B 7/185; H04W 24/10

(52) U.S. Cl. CPC H04W 72/541; H04B 7/18513; H04W 24/10

(57) ABSTRACT

The present disclosure relates to systems and methods for detecting and mitigating interference between satellite and terrestrial Radio Access Networks (RANs). Overlapping frequencies can cause co-channel interference, degrading terrestrial connections. This disclosure proposes dynamic interference mitigation by prioritizing either the satellite or terrestrial RAN based on conditions such as signal strength and coverage. Mitigating procedures are implemented to prevent interference, ensuring appropriate coexistence and maximizing the benefits of both technologies while preserving the performance advantages of terrestrial networks.

### SUMMARY

The present disclosure is directed to mitigating interference between terrestrial and satellite Radio Access Networks (RANs), substantially as shown and/or described in connection with at least one of the Figures, and as set forth more completely in the claims.

The integration of satellite RANs with terrestrial RANs can fill coverage gaps in remote areas, but overlapping frequencies can cause co-channel interference, degrading terrestrial connections. Conventional satellite RANs operate statically, leading to minimal real-time coordination with terrestrial networks. This disclosure proposes dynamic interference mitigation by prioritizing either the satellite or terrestrial RAN based on conditions such as signal strength and coverage. Mitigating procedures are implemented to prevent interference, ensuring coexistence and maximizing the benefits of both technologies while preserving the performance advantages of terrestrial networks. In some circumstances, a terrestrial base station may be prioritized over a satellite, such as when a UE served by a terrestrial base station is within a threshold distance of the terrestrial base station or the downlink signal from the terrestrial base station meeting certain key performance indicators (KPIs). When the terrestrial base station is prioritized, one or more mitigation procedures, such as reducing the transmission power of the satellite or modifying its coverage area, are implemented to prevent interference with the terrestrial base station. In other circumstances, such as when a UE is in a location with insufficient service from the terrestrial base station, the UE may be steered to a satellite connection by dynamically adjusting handover decision criteria to keep the UE connected to the relatively more stable satellite connection. Using the dynamic prioritization approach disclosed herein, UEs are able to maintain more stable and efficient connection, thereby enhancing overall network performance and user experience.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts a computing device suitable for use with implementations of the present disclosure;

FIG. 2 illustrates a representative network environment for use with implementations of the present disclosure;

FIGS. 3A-3E illustrates a network environment for use with implementing aspects of the present disclosure; and

FIG. 4 depicts a flow diagram of a method for use with the aspects of the disclosure described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32^{nd} Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions - including data structures and program modules - in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the integration of satellite RANs with terrestrial RANs offers the potential to fill coverage gaps in remote or underserved areas, enabling ubiquitous connectivity. However, terrestrial base stations, with their high capacity and low latency, remain the preferred option for user equipment (UE) in areas where strong terrestrial coverage is available. Challenges arise when satellite and terrestrial cells operate on overlapping frequencies, creating co-channel interference or harmonic distortion that degrades the quality of the terrestrial connection. This interference, originating from satellite transmissions, can elevate noise levels and reduce the signal-to-interference-plus-noise ratio (SINR) for UEs served by terrestrial base stations, diminishing their performance. Addressing these interference issues is crucial to ensure seamless coexistence of satellite and terrestrial networks, maximizing the benefits of both technologies while preserving the capacity advantages of terrestrial networks in areas where they are available.

Conventionally, satellite RANs, such as those deployed by non-terrestrial network (NTN) operators, typically operate in a relatively static configuration with respect to frequency usage, power levels, and coverage patterns, relying on predefined spectrum allocation agreements rather than dynamic interference mitigation. These satellite RANs are often managed independently of terrestrial cellular networks, leading to minimal real-time coordination or deconfliction between the two systems. As a result, when satellite RANs operate on overlapping or adjacent frequency bands with terrestrial RANs, they can introduce co-channel interference and elevate noise levels, particularly for UEs connected to terrestrial base stations in areas of strong terrestrial coverage. This interference undermines the advantages of terrestrial networks, such as their superior capacity and low latency, thereby creating a need for improved systems and methods to enable coexistence between satellite and terrestrial RANs while preserving the performance benefits of terrestrial connections.

Unlike conventional solutions, the present disclosure is directed to systems and methods for detecting and mitigating the overlap between satellite and terrestrial RANs. In response to identifying problematic overlapping coverage between a satellite RAN and a terrestrial RAN being predicted or observed, a process of selecting a priority RAN and mitigating the deprioritized RAN takes place. In some situations, the terrestrial RAN will be prioritized, primarily in areas of strong terrestrial coverage; whereas, in other situations, namely where terrestrial signaling is relatively weak or terrain obstructs terrestrial signal paths, the satellite RAN is prioritized. Where the terrestrial RAN is prioritized, one or more mitigating procedures may be implemented by the satellite RAN to prevent interference with the terrestrial coverage area. When the satellite RAN is prioritized, UEs in an overlapping coverage area may have modified handover procedures that encourage the UEs to stay connected to the satellite(s).

Accordingly, a first aspect of the present disclosure is directed to a system for mitigating co-channel interference. The system comprises a terrestrial radio access network (RAN) node configured to wirelessly communicate with a user equipment (UE). The system further comprises one or more computer processing components configured to perform operations. The operations comprise determining that a satellite transmitting a forward downlink signal is causing co-channel interference with one or more wireless channels used by the base station to communicate with a UE within a predetermined distance of the base station when a projection of the satellite is at a first position. The operations further comprise, based on said determination, communicating an instruction to the satellite to modify a transmission profile of the forward downlink signal.

Another aspect of the present disclosure is directed to a system for mitigating co-channel interference. The system comprises one or more networked computer processing components communicatively coupled to a base station of a terrestrial radio access network (RAN) and a satellite of a satellite RAN, and configured to perform operations. The operations comprise determining that an overlapping coverage area exists in a first location, based on one or more reports from the first location indicating the existence of a downlink signal transmitted by a base station of a terrestrial RAN and a forward downlink signal transmitted by a satellite of a satellite RAN. The operations further comprise, in response to said determination and a second determination that a trigger condition is satisfied, implementing a modified handover protocol for a UE in the first location instead of using a default handover protocol, the modified handover protocol causing the UE to connect or remain connected to the satellite, wherein the default handover protocol would have caused the UE to connect or remain connected to the base station.

Another aspect of the present disclosure is directed to a method for mitigating co-channel interference. The method comprises determining that a threshold high level of co-channel interference and a trigger condition exists at a first location. The method further comprises determining, based on the trigger condition, that a first cell of a first radio access network (RAN) should be prioritized over a second cell of a second RAN, wherein only one of the first RAN and the second RAN is a satellite RAN. The method further comprises, in response to determining that the first cell should be prioritized, implementing one or more mitigation procedures.

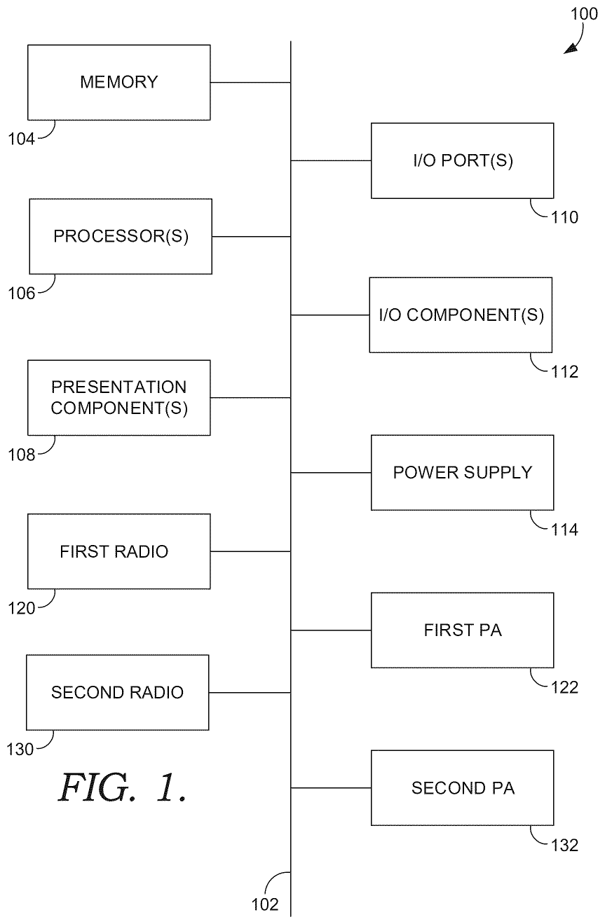

Referring to FIG. 1, a representative computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of one example of a computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. The memory 104 may take the form of solid-state memory, hard drives, optical-disc drives, etc. Computing device 100 includes one or more processors 106 that read data from various entities such as bus 102, memory 104 or I/O components 112. One or more presentation components 108 presents data indications to a person or other device. The one or more presentation components 108 may comprise one or more of a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

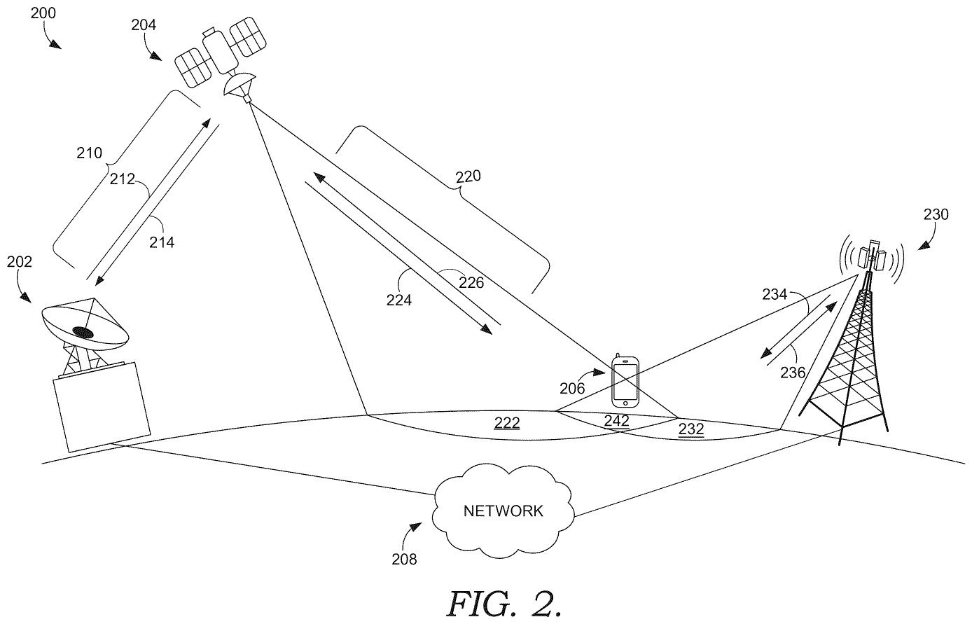

Turning now to FIG. 2, a representative network environment is illustrated in which implementations of the present disclosure may be employed. Such a network environment is illustrated and designated generally as network environment 200. At a high level the network environment 200 comprises a satellite radio access network (RAN) a terrestrial RAN, a UE 206, and a network 208. In aspects, the satellite RAN comprises at least a gateway 202 and a satellite 204. Though the composition of network environment 200 illustrates objects in the singular, it should be understood that more than one of each component is expressly conceived as being within the bounds of the present disclosure; for example, the network environment 200 may comprise multiple gateways, multiple distinct networks, multiple UEs, multiple satellites that communicate with a single gateway or multiple gateways, multiple satellites that may have inter-satellite links, multiple terrestrial base stations, and the like. Though certain objects of network environment 200 are illustrated in a certain form, it should also be understood that they may take other forms; for example, even though the UE 206 is illustrated as a cellular phone, a UE suitable for implementations with the present disclosure may be any computing device having any one or more aspects described with respect to FIG. 1, and even though the terrestrial base station 230 is illustrated as a macro cell mounted on a tower, a terrestrial base station suitable for use with the present disclosure is any terrestrial station configured to transmit signals to and receive signals from the UE 206 (e.g., a small cell, pico cell, relay, and the like).

The gateway 202 may be said to be communicatively connected to the network 208 and the satellite 204. The gateway 202 may be connected to the network 208 via one or more wireless or wired connections and is connected to the satellite 204 via a feeder link 210. The gateway 202 may take the form of a device or a system of components configured to communicate with the UE 206 via the satellite 204 and to provide an interface between the network 208 and the satellite 204. Generally, the gateway 202 utilizes one or more antennas to transmit signals to the satellite 204 via a forward uplink 212 and to receive signals from the satellite 204 via a return downlink 214. The gateway 202 may communicate with a plurality of satellites, including the satellite 204. The network 208 comprises any one or more public or private networks, any one or more of which may be configured as a satellite network, a publicly switched telephony network (PSTN), or a cellular telecommunications network. In aspects, the network 208 may comprise a satellite network connecting a plurality of gateways (including the gateway 202) to other networks, a cellular core network (e.g., a 4G, 5G, of 6G core network, an IMS network, and the like), and a data network. In such aspects, each of the satellite network and the cellular core network may be associated with a network identifier such as a public land mobile network (PLMN), a mobile country code, a mobile network code, or the like, wherein the network identifier associated with the satellite network is the same or different than the network identifier associated with the cellular network.

The satellite 204 is generally configured to provide wireless communication service to the UE 206 while in a satellite coverage area 222. In aspects where the satellite 204 is a bent pipe type, the satellite 204 may primarily operate by relaying communications between the gateway 202 and the UE 206. In aspects where the satellite 204 is processing or regenerative type, the satellite 204 may handle at least some signal processing, routing, switching, and resource allocation/scheduling on board, while still using a connection to the gateway 202 as a backhaul to the network 208. The satellite 204 communicates with the gateway using the feeder link 210 and communicates with the UE 206 using a user link 220. The user link 220 comprises a forward downlink 224 used to communicate signals from the satellite 204 to the UE 206 and a return uplink 226 used to communicate signals from the UE 206 to the satellite 204. Though a single forward downlink 224 and a single return uplink 226 are illustrated, the UE 206 may utilize multiple downlinks and/or multiple uplinks to communicate with the satellite 204, using any one or more frequencies as desired by a satellite or network operator. The satellite 204 may communicate with the UE 206 using any wireless telecommunication protocol desired by a network operator, including but not limited to 3G, 4G, 5G, 6G, 802.11x, Bluetooth and the like.

The satellite coverage area 222 is defined as an area in which the satellite 204 is configured to provide service at a given point in time. The satellite 204 has a projection, which refers to the geodetic sub-satellite point on the Earth's surface where a line drawn from the satellite to the Earth's center intersects the ground, dynamically changing for non-geostationary orbits and remaining fixed for geostationary satellites. The coverage footprint, which comprises the satellite coverage area 222, is the geographical area on Earth's surface that receives the satellite's signal, defined by the projection and shaped by the satellite's antenna pattern. The satellite 204 may communicate using one wide beam or a plurality of spot beams. Spot beams are localized, high-intensity transmission beams within the coverage footprint, designed to enhance spectral efficiency and support frequency reuse across distinct regions. Wide beams are satellite transmission patterns that covers a large geographical area, typically the entire visible hemisphere or a substantial portion of the Earth's surface within the satellite's coverage range. Unlike spot beams, which focus energy on smaller, localized areas, wide beams distribute signal power more uniformly over vast regions. Though illustrated as using one wide beam providing coverage to the satellite coverage area 222 for simplicity, the satellite 204 may be configured to utilize spot beams.

Generally, the satellite 204 is characterized by its orbit around the earth. The orbit of any particular satellite will vary by operator desire and/or intended use; for example, a satellite suitable for use with the present disclosure may be characterized by its maximum orbital altitude and/or orbital period as Low Earth Orbit (LEO), Medium Earth Orbit (MEO), and High Earth Orbit (HEO)—also referred to herein as characterizing an orbital plane. Though not rigidly defined, an LEO satellite may orbit with a maximum orbital altitude of less than approximately 1,250 miles, an MEO satellite may orbit with a maximum orbital altitude generally between 1,250 and 22,000 miles, and an HEO satellite may orbit with a maximum orbital altitude of greater than approximately 22,000 miles. In some, but not all cases, a satellite in HEO may be considered geosynchronous (i.e., geosynchronous earth orbit (GEO)) on the basis that its orbital period is approximately equal to the length of a sidereal or solar day (approximately 24 hours); generally, a satellite in geosynchronous orbit will appear to be in the same position relative to a fixed point on the surface of the earth 208 at the same time each day. A geostationary orbit is a special type of geosynchronous orbit with the Earth's equator with each of an eccentricity and inclination equal to zero. Some satellites in HEO and all that are in LEO or MEO have an orbital period that is different than the length of a sidereal/solar day and are considered to be non-geosynchronous and do not remain stationary relative to a fixed position on the surface of the Earth. As used herein, a satellite in LEO has a lower orbital plane than a satellite in MEO or HEO, an MEO satellite has a higher orbital plane than a satellite in LEO, and an HEO satellite has a higher orbital plane than a satellite in LEO or MEO.

The network environment 200 comprises one or more terrestrial base stations, represented by terrestrial base station 230. The terrestrial base station 230 is generally configured to relay communications between the network 208 and one or more UEs, such as the UE 206. The terrestrial base station 230 communicates signals to the UE 206 using a terrestrial downlink 234 and receives signals from the UE 206 using a terrestrial uplink 236. The terrestrial base station 230 may communicate with the UE 206 using any wireless telecommunication protocol desired by a network operator, including but not limited to 3G, 4G, 5G, 6G, 802.11x and the like. Though shown as having a single beam providing coverage to a terrestrial coverage area 232, the terrestrial base station 230 may be configured to utilize a plurality of individual beams to communicate with multiple different areas at or near the same time. Similarly, though a single terrestrial downlink 234 and a single terrestrial uplink 236 are illustrated, the UE 206 may utilize multiple downlinks and/or multiple uplinks to communicate with the terrestrial base station 230, using any one or more frequencies as desired by a mobile network operator.

In aspects of the present disclosure, there may exist an overlapping coverage area 242, wherein the satellite coverage area 222 and the terrestrial coverage area 232 at least partially overlap. In instances where the satellite 204 and the terrestrial base station 230 utilize the same radio frequency spectrum resources, co-channel interference may exist in and/or around the overlapping coverage area 242. Generally, co-channel interference is a type of interference that occurs in telecommunications when two or more transmitters, such as the satellite 204 and the terrestrial base station 230, broadcast on the same frequency channel. The interference can lead to reduced signal quality and even cause a loss of communications for UEs in or near the overlapping coverage area 242, such as the illustrated instance, wherein the UE 206 is located in the overlapping coverage area 242. Though illustrated in FIG. 2 as being an overlap of the satellite coverage area 222 and the terrestrial coverage area 232, the overlapping coverage area 242 of the present disclosure is not limited to where intended coverage areas (i.e., cells) overlap, but rather where a threshold high level of co-channel interference occurs.

The network environment 200 comprises one or more computer processing components that are configured to perform operations for monitoring and mitigating out of band emissions from the satellite 204. The one or more computer processing components may be located in (or part of) any one or more of the satellite 204, the terrestrial base station 230, and the network 208. At a high level, said operations comprise determining that an interference condition exists, determining a trigger condition, determining whether the terrestrial base station 230 or the satellite 204 should be prioritized based on the trigger condition, and mitigating the effects of the non-prioritized station on the UE 206.

In aspects of the present disclosure, an interference condition is identified that leads to subsequent operations. Generally, the interference condition is defined as one or more observations that emissions form the satellite 204 are causing interference with the UE 206 or the terrestrial base station 230. The interference condition may be met based on a determination that the UE 206 is located in the overlapping coverage area 242 and that a frequency/band used by the forward downlink 224 is the same as (or within a threshold similar range of) a frequency/band used by the terrestrial downlink 234. The interference condition may be met based on an observation by the UE 206 or the terrestrial base station 230 that a threshold high level of noise or co-channel interference exists at a threshold wide portion of the spectrum used by the terrestrial base station 230. The interference condition may be met based on a detection of harmonic signals produced by the satellite 204. The interference condition may be responsive or predictive. In a responsive aspect, the interference condition is satisfied in response to a measurement or detection of any one or more of the triggers described herein by the UE 206 and/or the terrestrial base station 230. In predictive aspects, the interference condition may be considered to be satisfied in a second time period when an interference condition was previously observed by the satellite 204 when its projection was in a first location at a first time period and the satellite 204's orbit is determined to be within a threshold distance of the first projection in the second time period.

Based on a determination that one or more interference conditions exist, aspects of the present disclosure will determine a trigger condition, which is used to determine whether the terrestrial base station 230 or the satellite 204 should be prioritized. In some aspects, the prioritization may be static; if the overlapping coverage area 242 comprises the terrestrial base station 230's location, an area in vicinity of the terrestrial base station 230 may have a static prioritization over the satellite 204. In other aspects, the prioritization may be dynamic; in some circumstances the satellite 204 may be prioritized in the overlapping coverage area 242, and in other circumstances the terrestrial base station 230 may be prioritized in the overlapping coverage area 242.

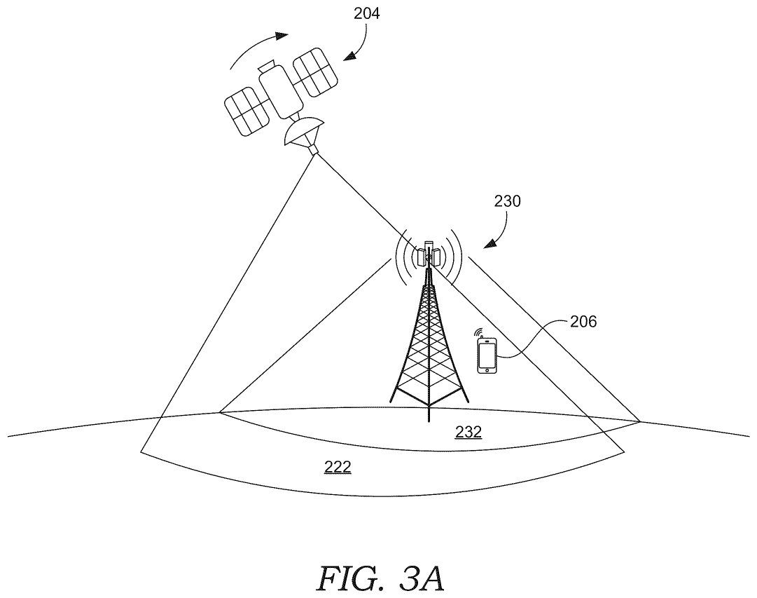

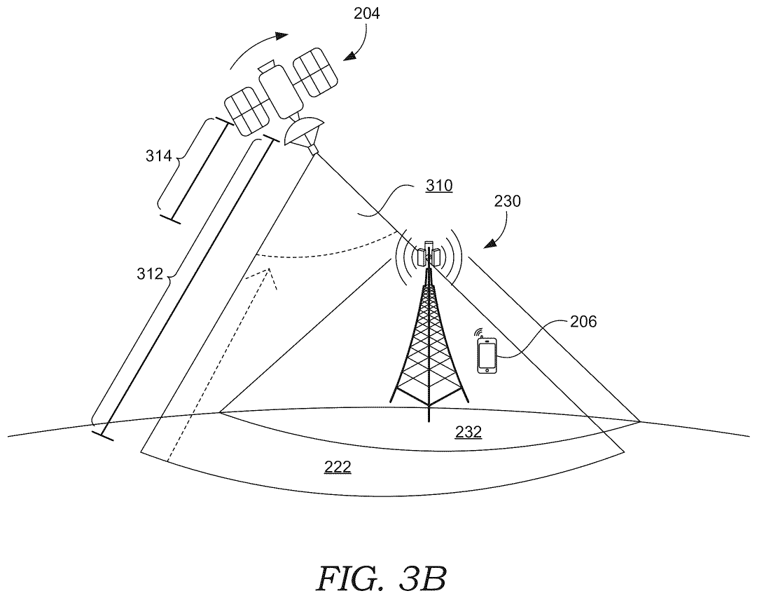

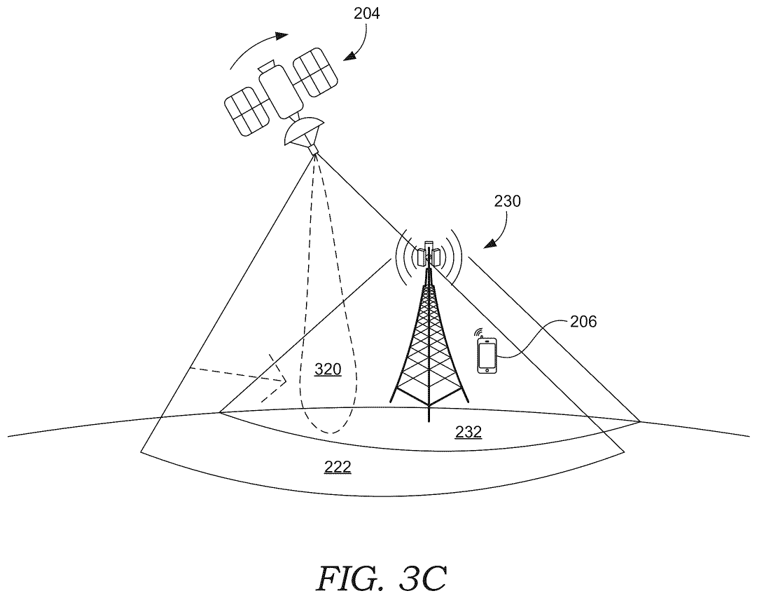

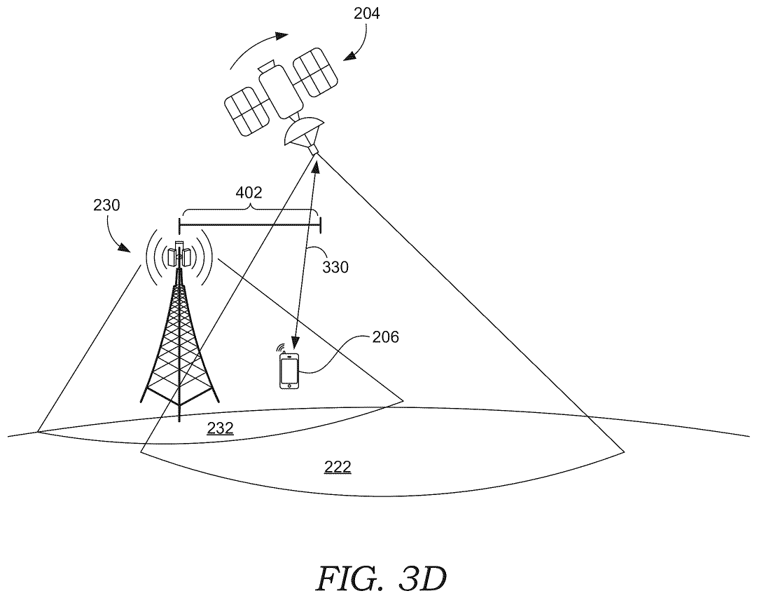

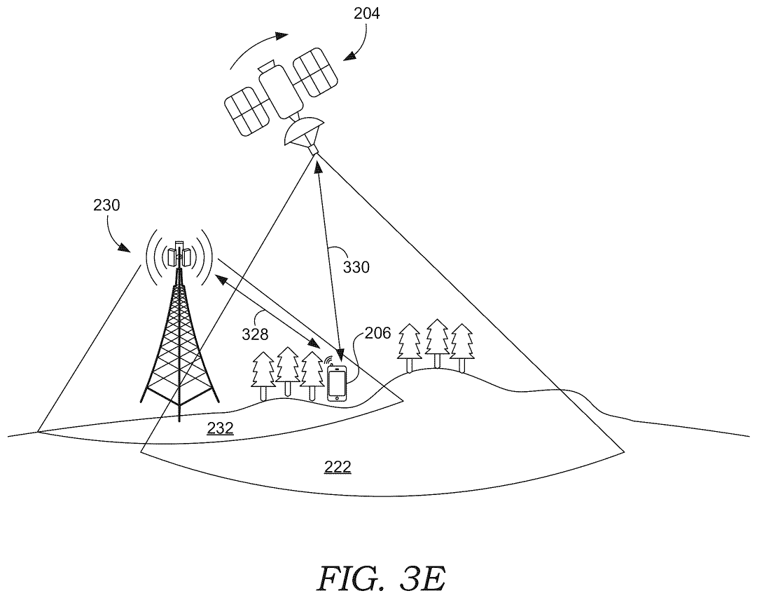

Turning now to FIGS. 3A-3E, a simplified network environment 300 is provided for illustrating various RAN prioritization scenarios. The network environment comprises the terrestrial base station 230, the satellite 204, the terrestrial coverage area 232, and the satellite coverage area 222 of FIG. 2. With reference to FIG. 3A, the network environment 300 illustrates an interference condition described with respect to FIG. 2 that can be mitigated by one or more of the solutions illustrated in FIGS. 3B-3E. In FIGS. 3A-3C, the satellite coverage area 222 comprises the terrestrial base station 230 and the UE 206. In the interference conditions illustrated in FIGS. 3A-3E, the interference condition may be based on at least one of the terrestrial base station 230 and the UE 206 reporting or detecting a threshold degradation in one or more key performance indicators (KPIs). Said threshold degradation may take the form of a noise floor that has risen greater than a threshold amount over at least a threshold portion of the spectrum used by the terrestrial base station 230 to communicate with the UE 206, a threshold low (or threshold decrease of) signal to interference noise ratio (SINR), a threshold low (or threshold decrease of) reference signal receive quality (RSRQ). In other aspects, determining that the interference condition exists may be based on determining that an overlapping coverage area exists based on measurement reports received from the UE 206.

With reference to FIGS. 3B-3C, the one or more interference conditions are likely to degrade the performance of wireless connections between the UE 206 and the terrestrial base station 230. Once the interference condition is identified, one or more trigger conditions are determined in order to determine that the terrestrial base station 230 should be prioritized over the satellite 204 in a first location. In a first aspect, the trigger condition comprises determining that the UE 206 is within a threshold distance of the terrestrial base station 230 (e.g., the threshold may be in the range of 5 -15 miles, depending on the height of the radiating elements of the terrestrial base station 230 and the frequencies used by the terrestrial base station 230). In a second aspect, the trigger condition comprises determining that a downlink signal transmitted by the terrestrial base station 230 has one or more key performance indicators (KPIs) better than a predetermined threshold. The one or more KPIs may comprise a threshold high reference signal receive power (RSRP), a threshold high RSRQ, a threshold high SINR, or any other KPI desirable by a mobile network operator that indicates stability and suitability of the downlink signaling from the terrestrial base station 230. In either aspect, said trigger condition(s) are used as a basis for determining that the terrestrial base station 230 should be prioritized over the satellite 204

Turning now to FIG. 3B, a first mitigation procedure is illustrated in response to determining that the terrestrial base station 230 should be prioritized over the satellite 204. Whether by using a tunable attenuator or by reducing the transmission power of the satellite 204 used to communicate the forward downlink, the satellite coverage area may be reduced from the pre-mitigated satellite coverage area 222 to a mitigated satellite coverage area 310, characterized by reducing a propagation distance of the forward downlink signals from a first propagation distance 312 to a shortened propagation distance 314. By sufficiently reducing the strength of the forward downlink signaling, the signals from the satellite 204 are less likely to interfere with the terrestrial base station 230 or the UE 206.

Turning now to FIG. 3C, a second mitigation procedure is illustrated in response to determining that the terrestrial base station 230 should be prioritized over the satellite 204. The second mitigation procedure comprises modifying the projection or the satellite 204 coverage area 222. In a first aspect, the projection of the satellite 204 may be modified, particularly if the one or more trigger conditions is predictive. By modifying the projection of the satellite 204, with or without additional beamforming, the satellite coverage area 222 may be shifted away from the terrestrial base station 230, the terrestrial coverage area 232, and/or the UE 206. In a second aspect, the satellite coverage area may be modified from a pre-mitigated coverage area 222 to a reduced coverage area 320. The reduced coverage area 320 may be formed by beamforming the forward downlink signaling (or reducing the beamwidth of the forward downlink signaling), away from the terrestrial base station 230 the terrestrial coverage area 232, and/or the UE 206. In aspects wherein the satellite 204 uses a plurality of spot beams to communicate to the satellite coverage area 232, each spot beam of the plurality of spot beams may be said to provide coverage for a unique subset of the satellite coverage area 232; in such aspects, and in response to a determination that the terrestrial base station 230 should be prioritized, the transmission profile of the satellite may be modified by deactivating one or more the spot beams associated with the unique subset of the satellite coverage area located within a threshold distance of the terrestrial base station 230.

In FIG. 3D, a first hypothetical is illustrated wherein the satellite 204 should be prioritized over the terrestrial base station 230. In the implementation illustrated by FIG. 3D, the trigger condition is determined to be that the UE 206 is not well-served by the terrestrial base station 230. In a first aspect, the trigger condition may comprise the first location being a distance 402 greater than a threshold distance from the terrestrial base station 230. In a second aspect, the trigger condition may comprise the downlink signal transmitted by the terrestrial base station 230 having one or more key performance indicators (KPIs) worse than a predetermined threshold (e.g., threshold low RSPR, threshold low RSRQ, threshold poor SINR, or any other KPI desirable by a mobile network operator to premise a decision that the terrestrial downlink signal is insufficient for serving the UE 206).

In FIG. 3E, a second hypothetical is illustrated wherein the satellite 204 should be prioritized over the terrestrial base station 230. In the implementation illustrated by FIG. 3E, the trigger condition is determined to be that the UE 206 is in a first location that is not well-served by the terrestrial base station 230 based on the terrain or obstacles at the first location or between the first location and the terrestrial base station 230. In aspects, such a trigger condition may be determined based on one or more KPIs being worse than the predetermined threshold greater than a predetermined percentage of an observation time period, and wherein the one or more KPIs are better than the predetermined threshold at a point in in the observation time period. For example, if the UE 206 experienced an RSRP of the terrestrial downlink signal 328 that was greater than the minimum threshold for 50% of the observation time period and was less than the minimum threshold for 50% the observation time period, and if the minimum percentage of stability was 80%, then the trigger condition would be satisfied. This trigger condition may be particularly likely wherein the UE 206 is moving in an area with alternating periods of good/poor line of sight with the terrestrial base station 230. In aspects, the trigger condition may be further based on a forward downlink signal 330 having one or more KPIs greater than a predetermined threshold, or greater than the predetermined threshold for greater than a threshold percentage of the observation period.

With reference to FIGS. 3D-3E, based on any one or more of the described trigger conditions at the first location, the satellite 204 may be prioritized over the terrestrial base station 230 in the first location. In response, a handover protocol is modified from the default handover protocol to a modified handover protocol. The modified handover protocol is designed to prioritize the UE 206 connecting to or remaining connected to the satellite 204 under specific conditions. These conditions may include, but are not limited to, signal strength thresholds, quality of service (QoS) requirements, and network load balancing parameters. Under the same conditions, the default handover protocol would have instructed the UE to handover to the terrestrial base station 230. The modified handover protocol achieves this by dynamically adjusting the handover decision criteria, incorporating additional parameters such as historical connection stability and predicted mobility patterns of the UE. This ensures that the UE maintains a more stable and efficient connection with the satellite 204 instead of camping on the relatively less stable terrestrial base station 230.

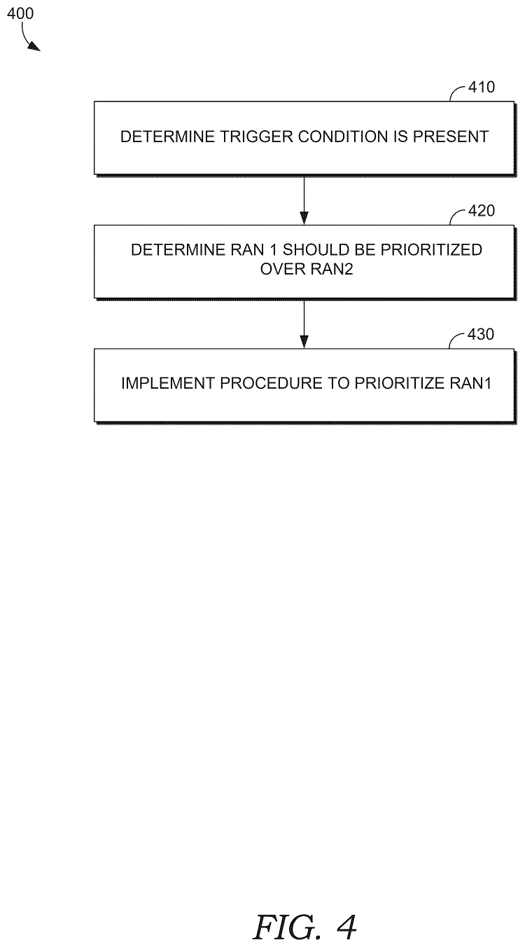

Turning now to FIG. 4, a flow chart representing a method 400 is provided. At a first step 410 it is determined that a threshold high level of interference (co-channel or harmonic-based) and a trigger condition exist at a first location, according to any one or more aspects described above with respect to FIGS. 2-3E. At a second step 420, it is determined that a first cell of a first RAN should be prioritized over a second cell of a second RAN at the firs location based on the trigger condition, wherein only one of the first RAN and the second RAN is a satellite RAN (and wherein the other RAN is a terrestrial RAN), according to any one or more aspects described above with respect to FIGS. 2-3E. At a third step 430, one or more mitigation procedures are implemented in response to determining that the first cell should be prioritized, according to any one or more aspects described above with respect to FIGS. 2-3E.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for mitigating co-channel interference, the system comprising:
a base station of a terrestrial radio access network (RAN) node configured to wirelessly communicate with a user equipment (UE); and
one or more computer processing components configured to perform operations comprising:
determining that a satellite transmitting a forward downlink signal is causing co-channel interference with one or more wireless channels used by the base station to communicate with a UE within a predetermined distance of the base station when a projection of the satellite is at a first position; and
based on said determination, communicating an instruction to the satellite to modify a transmission profile of the forward downlink signal.

2. The system of claim 1, wherein said determination comprises determining that a noise level exceeds a predetermined threshold strength across a greater than threshold range of the one or more channels used by the base station.

3. The system of claim 2, wherein the forward downlink signal is communicated on the one or more channels used by the base station.

4. The system of claim 2, wherein a harmonic signal created by transmitting the forward downlink signal is on the one or more channels used by the base station.

5. The system of claim 2, wherein the determination is reactive to a real-time measurement report.

6. The system of claim 2, wherein the determination is based on a previous measurement report when a projection of the satellite was in a first position at a first time, and wherein the instruction is further based on a determination that a projection of the satellite will be within a threshold range of the first position at an upcoming second time.

7. The system of claim 2, wherein the instruction to modify the transmission profile comprises using a tunable attenuator to reduce the transmission range of the forward downlink signal.

8. The system of claim 2, wherein the instruction to modify the transmission profile comprises modifying a beamform used to transmit the forward downlink to a second coverage area instead of a first coverage area, the second coverage area located further from the base station than the first coverage area.

9. The system of claim 2, wherein the satellite uses a plurality of spot beams to communicate to a satellite coverage area, each spot beam of the plurality of spot beams providing coverage for a unique subset of the satellite coverage area, and wherein the instruction to modify the transmission profile comprises deactivating one or more the spot beams associated with the unique subset of the satellite coverage area located within a threshold distance of the base station.

10. A system for mitigating co-channel interference, the method, comprising:
one or more networked computer processing components communicatively coupled to a base station of a terrestrial radio access network (RAN) and a satellite of a satellite RAN, and configured to perform operations comprising:
determining that an overlapping coverage area exists in a first location, based on one or more reports from the first location indicating the existence of a downlink signal transmitted by a base station of a terrestrial RAN and a forward downlink signal transmitted by a satellite of a satellite RAN; and
in response to said determination and a second determination that a trigger condition is satisfied, implementing a modified handover protocol for a UE in the first location instead of using a default handover protocol, the modified handover protocol causing the UE to connect or remain connected to the satellite, wherein the default handover protocol would have caused the UE to connect or remain connected to the base station.

11. The system of claim 10, wherein the trigger condition comprises the first location being greater than a threshold distance from the base station.

12. The system of claim 10, wherein the trigger condition comprises the downlink signal having one or more key performance indicators (KPIs) worse than a predetermined threshold, the one or more KPIs comprising a signal strength, a signal quality, or a signal to interference noise ratio (SINR).

13. The system of claim 12, wherein the trigger condition further comprises the one or more KPIs being worse than the predetermined threshold greater than a predetermined percentage of an observation time period, and wherein the one or more KPIs are better than the predetermined threshold at a point in in the observation time period.

14. A method for mitigating co-channel interference, the method, comprising:
determining that a threshold high level of co-channel interference and a trigger condition exists at a first location;
determining, based on the trigger condition, that a first cell of a first radio access network (RAN) should be prioritized over a second cell of a second RAN, wherein only one of the first RAN and the second RAN is a satellite RAN; and
in response to determining that the first cell should be prioritized, implementing one or more mitigation procedures.

15. The method of claim 14, wherein the first RAN is the satellite RAN, the second RAN is a terrestrial RAN, and wherein the one or more mitigation procedures comprises implementing a modified handover protocol for a UE in the first location instead of using a default handover protocol, the modified handover protocol causing the UE to connect or remain connected to the satellite, wherein the default handover protocol would have caused the UE to connect or remain connected to the base station.

16. The method of claim 15, wherein the trigger condition comprises determining that the first location is greater than a threshold distance from a base station associated with the second cell.

17. The method of claim 15, wherein the trigger condition comprises a downlink signal transmitted by the second cell having one or more key performance indicators (KPIs) worse than a predetermined threshold, the one or more KPIs comprising a signal strength, a signal quality, or a signal to interference noise ratio (SINR).

18. The method of claim 14, wherein the first RAN is a terrestrial RAN and the second RAN is the satellite RAN, and wherein the one or more mitigation procedures comprises modifying a transmission profile of the second cell, the modifying comprising at least one of using a tunable attenuator to reduce the signal strength of a forward downlink signal transmitted by a satellite associate with the second cell and modifying the transmission beamform of the second cell.

19. The method of claim 18, wherein the trigger condition comprises determining that the first location is less than a threshold distance from a base station associated with the first cell.

20. The method of claim 18, wherein the trigger condition comprises a downlink signal transmitted by the second cell having one or more key performance indicators (KPIs) better than a predetermined threshold, the one or more KPIs comprising a signal strength, a signal quality, or a signal to interference noise ratio (SINR).
